(19) United States
(12) Patent Application Publication
(10) Pub. No.: US 2013/0118628 A1
(43) Pub. Date: May 16, 2013

(54) Method of coating of a pipeline and an elastic sleeve device for the method

(71) Applicant: Peter Gorovits, Rehovot (IL)

(72) Inventor: Peter Gorovits, Rehovot (IL)

(21) Appl. No.: 13/373,474

(22) Filed: Nov. 16, 2011

(51) Int. Cl. F16L 55/00; F16L 9/18; B29C 65/52

(52) U.S. Cl. 138/108; 156/287; 138/141

(57) ABSTRACT

A method of coating a pipeline includes introducing into one of two open ends of a pipeline a quantity of a pasty coating material, inserting after the material in the one end an elastic sleeve device, and supplying compressed air into the one end.

### BACKGROUND OF THE INVENTION

The present invention relates to application of a protective coating on an inner surface of a pipeline of any length, and can be used for repair and maintenance of pipelines.

It is known to coat an inner surface of a metal pipe with a thermoplastic pipe or casing having an outer diameter which is somewhat greater than an inner diameter. This is disclosed in the publication Grinberg Z. A “Steel Pipes Coated with Polyethylene” M., “Metallurgia” 1973, page 34. In accordance with this technology a plastic pipe is irradiated, then it is heated to 140° C. and stretched by suspending a load until it elongates by 25%, and then a slow cooling is performed. During this process the initial diameter of the plastic pipe is restored due to expansion because of reduction of length, and a coating of the inner surface of the metallic pipe is carried out in this way.

This method cannot be used for coating of long parts of the pipe and needs a heavy, expensive, and energy-consuming equipment, and therefore it can be used only for coating of individual portions of pipes exclusively in a plant.

Also, a method of applying a polymeric protective coating on an inner surface of a pipeline as disclosed in SU 1404750. It includes introduction into a cavity of a pipeline of a polymeric thermoplastic material, fixing one of ends of a sleeve on an end of the pipeline, successive heating and pressing of the sleeve to the wall of the pipe with displacement of a heating zone before a pressing zone.

In this method the heating is performed until the surface of the sleeve in contact with the wall of the pipe is melted and the heating is performed by an annular induction furnace inside the sleeve, while the pressing of the sleeve to the inner surface of the pipeline is performed by a compressed air supplied into the sleeve.

This method is not usable for coating of long portions of the pipe. It also requires a heavy complicated equipment for heating of the pipes to be coated to 140-150° C. Moreover for pressing the sleeve by compressed air it is necessary to provide a high hermetization of the sleeve.

Another method of applying a polymeric protective coating on an inner surface of the pipeline is disclosed in RU 2028210 C1. It also includes introduction of a sleeve composed of thermoplastic material into an interior of the pipeline, fixing one of the ends of the sleeve on the end of the pipeline, successive heating and pressing of the sleeve to a wall of the pipe, with displacement of a heating zone before the pressing zone. In contrast to the previous invention, the sleeve of polyethylene or compositions based on it is utilized, which preliminarily is subjected to irradiation with subsequent longitudinal stretching, and the heating of the sleeve in the pipeline is carried out to 200-400° C. with a speed of displacement of the heating zone 0.3-1.0 m/min.

This method also cannot be used for coating of long portions of the pipe. In addition it requires a heavy complicated equipment for heating of the pipes to be coated and for pressing of the sleeve, while for pressing of the sleeve with compressed air it is necessary to provide a tight hermetization of the sleeve.

Various methods for coating of the inner surface of the pipeline are disclosed in Japanese patents JP 2005296729, JP 2068177, JP 6126230, JP 60007974, JP 61018475, JP 61245875, JP 62001483, JP 62001484, JP 2007196628. The methods disclosed in these references includes supplying of special gaseous mixtures into the pipelines and composed of compressed air and synthetic resin paint. The paint is uniformly distributed over the inner surface of the pipeline even in the case of changing diameter.

These solutions have certain advantages, and however they also have some disadvantages, in particular the necessity of providing a substantially expensive equipment for supplying a special gaseous mixture along all multi-kilometer length of the pipeline, and also impossibility of smoothing of the inner surface of the pipe for reducing hydraulical losses, since the paint is distributed over the inner surface of the pipeline in a very thin layer of several microns at most.

Other solutions are also known to provide coating of multi-kilometer pipeline relatively inexpensively and to reduce the hydraulic resistance. However, none of the proposed solutions actually achieve these objectives.

In a Soviet Army and now in a Russian Army for constructing field pipelines PMT 100, PMT 150 a rubber elastic sleeve is provided for cleaning a cavity of the assembled pipeline from dirt, leaves, stones and other garbage. This is disclosed for example in “Manual of Sergeant of Pipeline Troopes”, M, “Voenizdat”, 2006, page 385″ Field Pipeline PMT P100 Instruction for Use and Technical Service, M “Voenizdat”, 1080, page 106. The rubber elastic sleeve includes two rubber cylindrical sleeves which are located one after the other and have ends which are thinned. A nose part of the rubber elastic sleeve is formed as a cylinder and made heavier with the use of metal. During assembly of the pipeline the rubber elastic sleeve is introduced into a pipeline and moved along the whole length of the assembled pipeline, so that the elastic sleeves collect all dirt in front of them.

### SUMMARY OF THE INVENTION

Accordingly, it is an object of the present invention to provide a method of coating of a pipeline and an elastic sleeve device for the method, which eliminates the disadvantages of the prior art and allows to provide inexpensively a coating of a new pipeline or a repair of the used pipeline having practically any length and any diameter and at the same time to ensure the lowest possible hydraulic resistance.

In keeping with these objects and with others which will become apparent hereinafter, one feature of the present invention resides, briefly stated, in a method of coating a pipeline, comprising introducing into one of two open ends of a pipeline a quantity of a pasty coating material; inserting, after the material, in said one end an elastic sleeve device; and supplying compressed air into the one end.

Another feature of the present invention resides, in supplying the compressed air through an exhaust end of a compressor connected to the one end of the pipeline.

A further feature of the present invention resides in forming the sleeve device from the elastic material in the form of a circular cylinder, providing in a tail part of said cylinder at least two circular elastic sleeves; thinning end parts of said sleeves; forming a nose part of the cylinder as a screw.

The present invention also resides in forming the nose part of the cylinder as an Archimedes screw.

A further feature of the present invention resides in an elastic sleeve device inserted into an end of a pipeline for its coating after introducing into the one end of the pipeline a pasty coating material, wherein said elastic sleeve device is configured to communicate with a source of a compressed air.

Still an additional feature of the present invention resides in said elastic sleeve device configured to be connected with an exhaust flange of a compressor.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 illustrates a new method of coating and a device provided for it.

### DESCRIPTION OF THE PREFERRED EMBODIMENTS

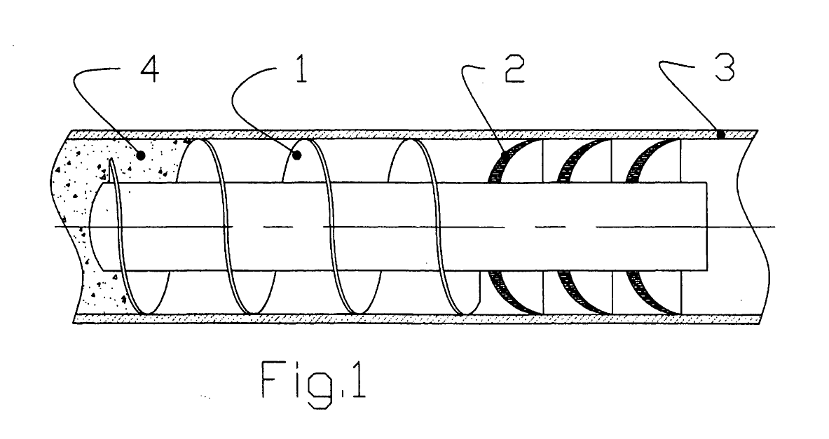

In accordance with the present invention a rubber elastic sleeve device is shown in FIG. 1.

The rubber elastic sleeve device is composed of elastic material and has a plurality (at least two) elastic cylinderical sleeves 1. The sleeves 1 have ends which are thinned. A nose part of the rubber elastic device is formed as a screw 2, for example as an Archimedes screw.

In accordance with the present invention a calculated quantity of a pasty coating material 4, for example on the basis of resin, liquid glass, plastic mass, etc., is introduced into a flange or end of the pipeline 3. Then, a rubber elastic sleeve is introduced into the flange of the pipeline, and a compressor which is not shown in the drawings is connected. The outer diameter of the elastic sleeves 1 and the Archimedes screw 2 is equal to the inner diameter of the pipeline 3.

Due to pumping of a compressed air by the compressor, the elastic sleeves 1 are straightened and tightly abut against the inner surface of the pipeline 1. The compressed air pushes the rubber elastic sleeve device, and the rubber elastic sleeve device pushes the pasty coating material 4 before it. During this process, due to the presence of the Archimedes screw 2 in its nose part, the rubber elastic sleeve device will be forced to rotate which imparts a high stability of the rubber elastic sleeve device during its movement, and a continuous supply of the coating material to the elastic sleeves 1 is provided.

The elastic edges of the sleeves 1, during the movement of the rubber elastic sleeve, perform the role of spackles and they spackle the inner surface of the pipeline 3. Due to its elasticity the rubber elastic sleeve device is easily displaced in all turns and bends of the pipeline 1, in the pipelines to be coated having any length.

It will be understood that each of the elements described above, or two or more together, may also find a useful application in other types of methods and constructions differing from the type described above.

While the invention has been illustrated and described as embodied in a method of coating of a pipeline and an elastic sleeve device for the method, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method of coating a pipeline, comprising introducing into one of two open ends of a pipeline a quantity of a pasty coating material; inserting after the material in said one end an elastic sleeve device; and supplying compressed air into the one end.

2. A method as defined in claim 1, wherein said supplying includes supplying the compressed air through an exhaust flange of a compressor connected to the one end of the pipeline.

3. A method as defined in claim 1, further comprising forming the sleeve device from an elastic material and formed as a circular cylinder, providing in a tail part of said cylinder at least two circular elastic seals; and thinning end parts of said seals; forming a nose part of the cylinder as a screw.

4. A method as defined in claim 1, wherein said forming includes forming the nose part of the cylinder as an Archimedes screw.

5. An elastic sleeve device inserted into an end of a pipeline for its coating after introducing into the one end of the pipeline a pasty coating material, wherein said elastic sleeve device is configured to communicate with a source of a compressed air.

6. An elastic seal as defined in claim 5, wherein said elastic sleeve device is configured to be connected with an exhaust flange of a compressor.

7. An elastic seal as defined in claim 5, wherein the elastic sleeve device is composed of an elastic material and formed as a circular cylinder, with two elastic sleeves arranged in a tail part of the cylinder with a thinning end part of said sleeves and a nose part of said cylinder formed as a screw.

8. An elastic seal as defined in claim 5, wherein said nose part of said cylinder is formed as an Archimedes screw.
